(19) United States
(12) Patent Application Publication
(10) Pub. No.: US 2020/0338647 A1
(43) Pub. Date: Oct. 29, 2020

(54) COLLET CARRIER SYSTEM

(71) Applicant: Alan B. Tande, Simi Valley, CA (US)

(72) Inventor: Alan B. Tande, Simi Valley, CA (US)

(21) Appl. No.: 16/393,861

(22) Filed: Apr. 24, 2019

(51) Int. Cl. B23B 31/20

(52) U.S. Cl. CPC B23B 31/207

(57) ABSTRACT

A machine tool collet carrier includes a collet in a sleeve and a pin fixed to a collet joint that is movable in a sidewall slot of the sleeve.

### INCORPORATION BY REFERENCE

This application incorporates by reference, in their entireties and for all purposes, U.S. Pat. Nos. 7,043,805, 8,720,025, 7,117,773, 8,887,360, 6,611,418, 6,554,288, and 6,533,292.

### BACKGROUND OF THE INVENTION

### Field of the Invention

The present invention relates to an article of manufacture for use in improving machine tool operations. In particular, the present invention provides a carrier for a collet.

### Description of the Related Art

Machine tools such as lathes and milling machines are known. These machines utilize a collet chuck that fits into a machine tool spindle and that directly engages a collet, the collet for holding a workpiece that is rotated by the machine tool.

### SUMMARY OF THE INVENTION

A collet carrier system includes a collet and a collet carrier actuated by a drawbar. Embodiments of the collet carrier system may comprise one or more of: a machine tool with a spindle for rotating a workpiece about a horizontal axis; an adapter connected to the spindle, the adapter for engaging a first collet of a first size; a second collet of a second size, the second size being smaller than the first size and the second collet able to pass through a bore of the adapter; a collet carrier with a flared end inserted in the adapter bore, the flared end operable to engage a tapered section of the adapter bore; the second collet with a flared end inserted in the collet carrier, the flared end operable to engage a tapered section of a collet carrier bore; and, a drawbar connected to the collet, motion of the drawbar in a first direction for drawing the collet into collet carrier and for drawing the collet carrier into the adapter such that a workpiece within the collet is fixed within the collet.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 shows an open collet diagram of an embodiment of the collet carrier system according to the present invention.

FIG. 2 shows a closed collet diagram of an embodiment of the collet carrier system of the present invention according to the present invention.

FIG. 3 shows another open collet diagram of an embodiment of the collet carrier system of FIG. 1.

FIG. 4 shows selected parts of the collet carrier system of FIG. 1.

FIG. 5 shows cross section of the adapter of FIG. 1.

FIG. 6 shows another closed collet diagram of an embodiment of the collet carrier system of FIG. 1.

FIG. 7 shows an example of use of the collet carrier system.

### DESCRIPTION OF PREFERRED EMBODIMENTS

The disclosure provided in the following pages describes examples of some embodiments of the invention. The designs, figures, and description are non-limiting examples of the embodiments they disclose. For example, other embodiments of the disclosed device and/or method may or may not include the features described herein. Moreover, described features, advantages or benefits may apply to only certain embodiments of the invention and should not be used to limit the disclosed invention.

As used herein, the term “coupled” includes direct and indirect connections. Moreover, where first and second devices are coupled, intervening devices including active devices may be located therebetween.

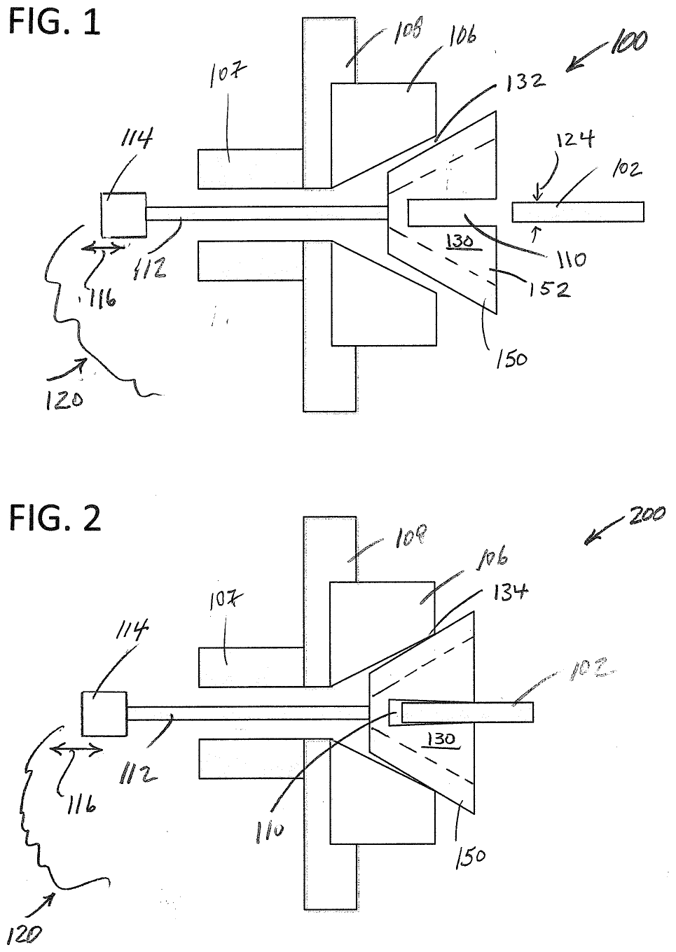

FIG. 1 shows an open collet diagram of an embodiment of the collet carrier system of the present invention 100. A machine tool 120 such as a lathe or a milling machine is shown. As used herein, machine tool refers to a device for rotating a tool relative to a workpiece. For example, a workpiece may be rotated about a horizontal axis or about a vertical axis.

The machine tool includes a motor 107 for rotating a spindle 108. Coupled to the spindle is an adapter 106 that connects the spindle to a collet 130. The collet includes a collet mouth 110 for receiving, directly or indirectly, a workpiece 102.

A drawbar 114 is directly or indirectly coupled to the collet 130. For example, an assembly or joint such as a rotatable assembly or joint 112 may couple the drawbar to the collet. Drawbar motion 116 toward the spindle 108 opens the collet mouth 110 as a gap 132 is created between the collet and the adapter 106.

FIG. 2 shows a closed collet diagram of an embodiment of the collet carrier system of the present invention 200. Here, motion 116 of the drawbar 114 away from the spindle 108 closes the collet mouth 110 when there is contact 134 between the collet 130 and the adapter 106.

As seen in the figures, a workpiece 102 of a particular size 124 determines the collet 130 used as the collet mouth 110 must receive the workpiece and movement of the drawbar 114 away from the spindle 108 must cause the collet mouth to close around and grasp the workpiece. For example, if a collet 152 cannot be used with an adapter 106 because the collet is too small for the adapter, a different, smaller adapter must normally be chosen.

The problem of a collet 152 that is too small for the adapter 106 can be resolved by a collet carrier 150 that is between the collet 152 and the adapter 106. For example, a 5C collet may be used in a 16C adapter when a collet carrier is between the collet and the adapter.

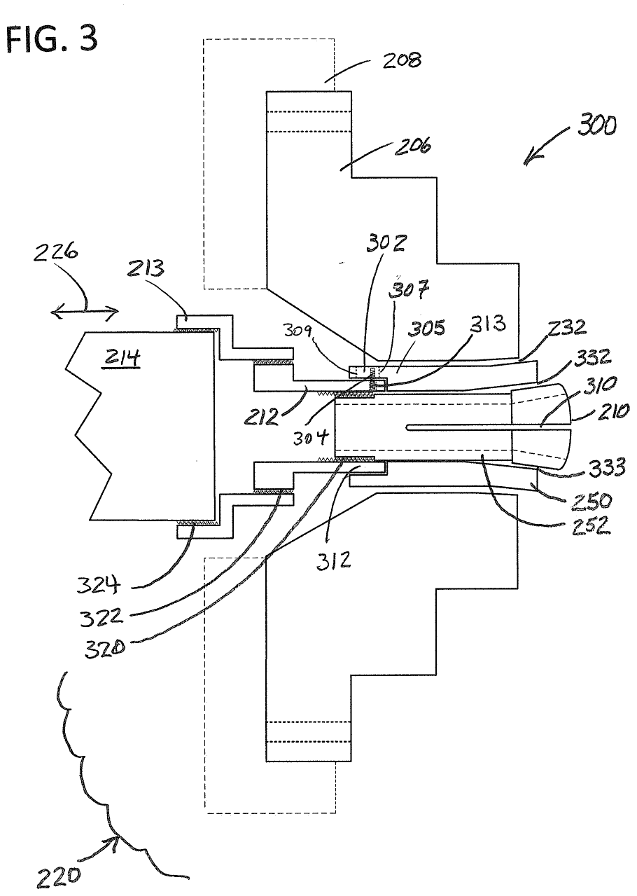

FIG. 3 shows another open collet diagram of an embodiment of the collet carrier system of the present invention 300. Here, a machine tool 220 includes a motor (not shown) for rotating a spindle 208. Coupled to the spindle is an adapter 206 that connects the spindle to a collet carrier 250. A collet 252 within the collet carrier includes a collet mouth 210 for receiving, directly or indirectly, a workpiece (not shown).

Connecting the drawbar 214 and the collet carrier 250 is a joint assembly 212, 213. A first joint element 212 is threadingly connected 324 to the drawbar and threadingly connected 322 at an opposite end to a second joint element 213. The second joint element is threadingly connected 320 to the collet carrier 250.

As shown, embodiments of the collet 252 have longitudinal slots 310 (3, 4, or more end slots) in a sidewall 312 that allow a collet mouth 210 to close around a workpiece when the collet mouth is compressed radially inward. And, some embodiments may include a collet pin 304 protruding from a first joint element sidewall 312 and projecting into a sidewall 305 of the collet carrier 250. The pin may be engaged 313 with the first joint element, threadingly engaged with the first joint element, or removably affixed by a similar means.

This pin in slot arrangement may a) limit motion of the collet carrier over the collet, b) prevent relative rotation of the collet carrier and the first joint element 212, c) slidingly engage the collet carrier and the first joint element, and/or d) provide for pushing or pulling the collet carrier via pin contact with the forward 307 or rearward 309 ends of the collet carrier slot 302.

A drawbar 214 moving along a horizontal axis 226 is directly or indirectly coupled to the collet 252. For example, an assembly such as a rotatable assembly 212, 213 may couple the drawbar to the collet. Drawbar motion 226 toward the spindle 208 may open the collet mouth 210 as a gap is created between the collet and the collet carrier 250. And, drawbar motion toward the spindle may create a gap between the collet carrier and the adapter 206, the gap serving to relieve radial pressure on the collet mouth.

During drawbar 214 motion toward the spindle 208, the collet 252 may be pushed away from the spindle, out of the adapter 206, and relative to the collet carrier 250. Relative motion between the collet and collet carrier may move the collet pin 304 to or toward a forward end 307 of the collet carrier slot 302. This drawbar motion moves the collet mouth 210 away from the collet carrier mouth 333 and creates the gap 332 between the collet mouth and the collet carrier. And, this drawbar motion may tend to move the collet carrier out of the adapter creating a gap 232 between the collet carrier and the adapter.

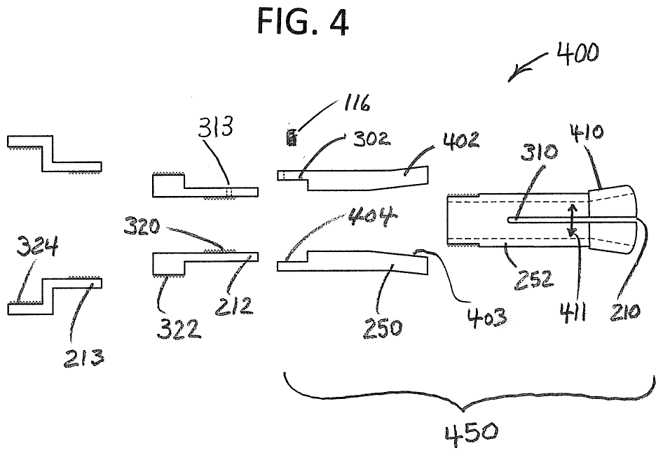

FIG. 4 shows selected parts of the collet carrier system 400. At right is the collet 252 which fits into the collet carrier 250. The collet carrier is threadingly engaged with a first joint element 212 which is threadingly engaged with a second joint element 213. The second joint element is connected to the drawbar 214.

The collet 252 has a tubular shape with a plurality of end slots. A nose 410 of the collet is flared in order to make an interference fit with a bore 403 of the collet carrier 250. Notably, as the collet nose enters the collet carrier, the nose is pressed inward as the slots narrow and a bore of the collet 411 is reduced to grab an inserted workpiece (not shown).

The collet carrier 250 has a somewhat tubular shape. A flared mouth 402 of the collet carrier is for receiving the collet 252 as explained above. Opposite the flared mouth, a stepped insertion end 404 may provide a stop for an inserted first joint element 212. For example, when the drawbar 214 pushes the collet forward, the first joint element is pushed into the collet carrier. Where the first joint element meets the collet carrier stop, the collet carrier may be pushed forward.

A drawbar 214 (see FIG. 3) is connected to the second joint element which is connected to the first joint element.

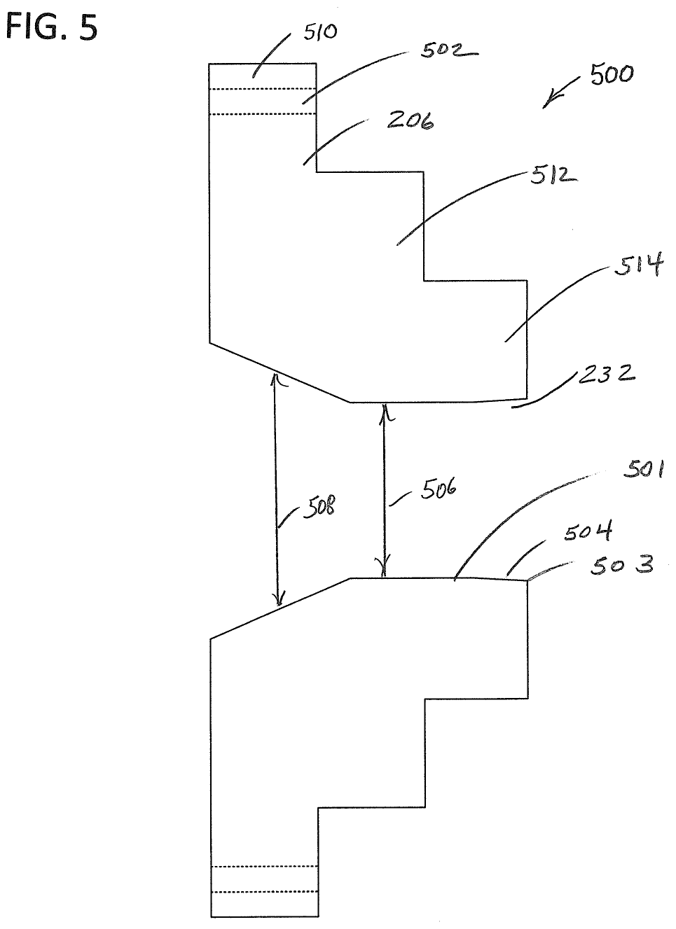

FIG. 5 shows the adapter cross-section 500. The adapter 206 is a cylindrical part with a central through hole that may be of varying diameter 506, 508. Where present, bolt holes in the adapter 502 provide a means for connecting the adapter to the spindle 208.

In various embodiments, the adapter 206 may have adjoining concentric sections, each successive section smaller than the previous section 510, 512, 514. A throat 501 of the adapter may include a flared section 504 for receiving and compressing the collet carrier nose 410 at the throat entry 503.

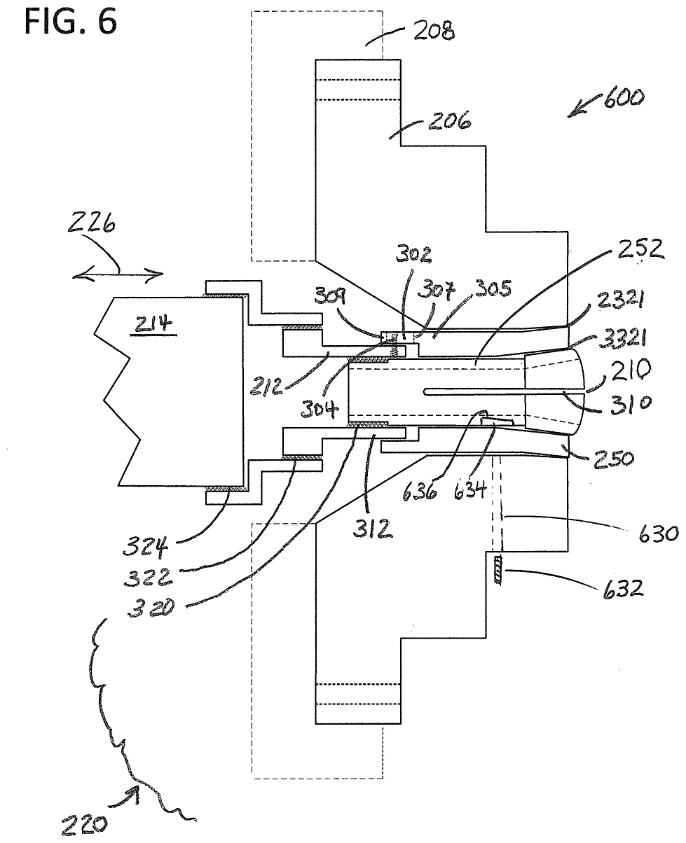

FIG. 6 shows another closed collet diagram of an embodiment of the collet carrier system of the present invention 600. FIG. 6 is similar to FIG. 5.

Here, drawbar motion 226 away from the spindle 208 may close the collet mouth 210 as a gap between the collet and the collet carrier 250 is closed. And, drawbar motion away from the spindle may close a gap between the collet carrier and the adapter 206, closing the gap serving to exert radial pressure on the collet mouth.

During drawbar 214 motion away from the spindle 208, the collet 252 may be pulled toward the spindle, into of the adapter 206, and relative to the collet carrier 250. Relative motion between the collet and collet carrier may move the collet pin 304 to or toward a rearward end 309 of the collet carrier slot 302. This drawbar motion moves the collet mouth 210 toward the collet carrier mouth 333 and closes the gap 3321 between the collet mouth and the collet carrier. And, this drawbar motion may tend to move the collet carrier into the adapter closing a gap 2321 between the collet carrier and the adapter.

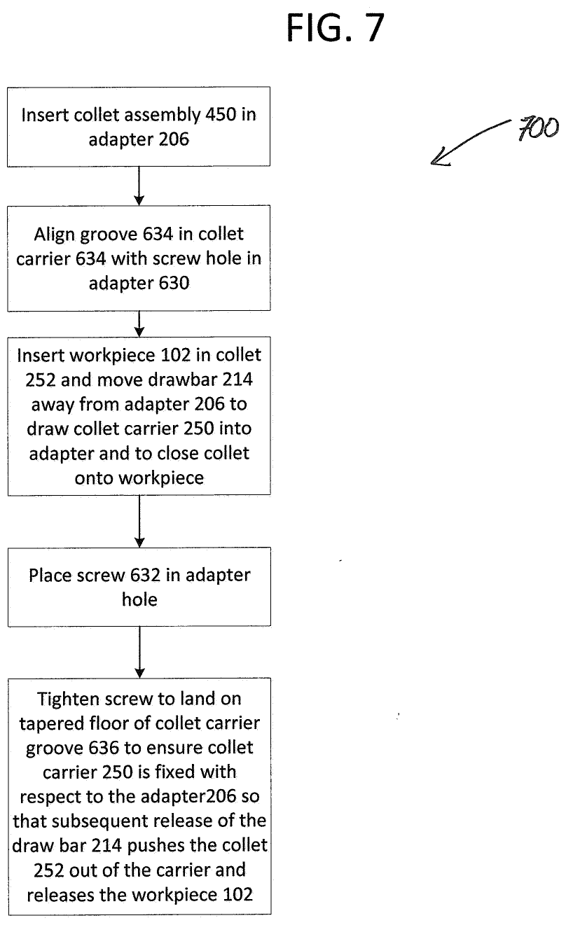

FIG. 7 shows one example of use of the collet carrier assembly 700. The collet assembly 450 is inserted in the adapter 20. A groove 634 in the collet carrier is aligned with a screw hole in the adapter 630. The workpiece 102 is inserted in the collet 252 and the drawbar 214 is moved away from the adapter to draw the collet carrier 250 into the adapter and to close the collet on the workpiece. A screw 632 is placed in the adapter hole. The screw is tightened to land on a tapered floor of the collet carrier groove 636 to insure the collet carrier is fixed with respect to the adapter so that subsequent release of the draw bar pushes the collet out of the carrier and releases the workpiece.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above described exemplary embodiments, but should be defined only in accordance with the following claims and equivalents thereof.

What is claimed is:

1. A collet carrier system comprising:
a machine tool with a spindle for rotating a workpiece about a horizontal axis;
an adapter connected to the spindle, the adapter for engaging a first collet of a first size;
a second collet of a second size, the second size being smaller than the first size and the second collet able to pass through a bore of the adapter;
a collet carrier with a flared end inserted in the adapter bore, the flared end operable to engage a tapered section of the adapter bore;
the second collet with a flared end inserted in the collet carrier, the flared end operable to engage a tapered section of a collet carrier bore; and,
a drawbar connected to the collet, motion of the drawbar in a first direction for drawing the collet into collet carrier and for drawing the collet carrier into the adapter such that a workpiece within the collet is fixed within the collet.

2. The collet carrier system of claim 1 further comprising:
a longitudinal slot in a sidewall of the collet carrier, the slot end near a step in the inside diameter of the collet carrier;
a pin fixed in a sidewall of the first joint element, the pin protruding into the collet carrier slot; and,
the pin preventing rotation of the collet carrier relative to the first joint element.

3. The collet carrier system of claim 2 wherein the collet carrier is fixed to the adapter via a set screw protruding from the adapter into a groove of the collet carrier and onto a collet carrier groove floor that is tapered such that the groove is deeper near the threaded end of the collet.
